(19) United States
(12) Patent Application Publication
(10) Pub. No.: US 2003/0172216 A1
(43) Pub. Date: Sep. 11, 2003

(54) Increasing the component capacity of adapters

(76) Inventor: Ralph Gundacker, Talheim/Neckar, BW (DE)

Correspondence Address: Timothy N. Trop, TROP, PRUNER & HU, P.C., 8554 KATY FWY, STE 100, HOUSTON, TX, 77024-1841, US

(21) Appl. No.: 10/093,187

(22) Filed: Mar. 7, 2002

(51) Int. Cl. G06F 13/00

(52) U.S. Cl. 710/300

(57) ABSTRACT

An adapter may have a plurality of sockets secured to a separate card that is in turn secured to the backside of the adapter. As a result, memory modules may be separated from other processor-based components that are positioned on the component side of the adapter. By providing modular sockets for receiving the memory modules, the user may have the option to select the memory that is incorporated on the adapter.

### BACKGROUND

This invention relates generally to adapters for processor-based systems.

Adapters or adapter cards are typically printed circuit boards that may be called expansion boards or expansion cards. In some cases, adapters may form an interface between a processor-based system, sometimes called a platform and various peripherals. Thus, typically adapters may perform functions different from those performed by the platform itself. As a result, the platform may be said to have an expansion capability and that expansion capability may be provided by adapters.

In some cases, a platform or processor-based system may be sold with a number of bus slots that can receive adapters. This permits the user to decide which additional functions the user wishes to incur the expense of obtaining. Thus, a platform may be susceptible to a number of additional functions that may be fulfilled by purchasing and installing the appropriate adapters.

Examples of adapters that may be utilized to control peripherals include video cards, sound cards, small computer system interface (SCSI) cards, three-dimensional graphics controllers, internal MODEMs, Integrated Services Digital Network (ISDN) adapters, additional parallel ports, video editing boards, special graphics cards, redundant array of independent disks (RAID) controllers, network interface cards, and fiber channel adapters, to mention a few examples. Some of these adapters have memory that is built in to store data. Other cards may be provided with installed processors or intelligent input/output controllers that need memory storage.

As reliance on adapters to fulfill various customer requirements has increased, the available size within platforms to receive these adapters has decreased. This is the case in both desktop computers and servers. As a result of the decrease in the size of the platform, the available adapters are difficult to install, especially where those adapters are called upon to provide increased functionality.

Conventionally, when an adapter needs memory, the memory is installed with other components on the adapter. Thus, a component side of an adapter card generally contains all of the integrated circuit devices. Standard dual in line memory modules (DIMMs) are commonly installed on adapters.

Because of the decreasing size of the platforms, so-called low profile peripheral component interconnect (PCI) adapters are used. These low profile adapters may, in one example, be about half the size of conventional adapters. As a result, the available area to mount the components on the component side of the adapter is becoming more limited. In addition, processors or bridges on the adapters may consume a large portion of the available footprint on the adapter. Moreover, as the available area on the adapter becomes more heavily populated with memory and processors, heat dissipation can be disordered. Another problem is that on the lower profile cards, the placement of cable connectors to the adapter under a module become more difficult.

Generally, integrated circuits are fixed to the adapters by soldering. Therefore, it is not feasible for the user to alter those installed components.

Thus, there is a need for solutions that allow more components to be placed on the same adapter. Moreover, in some cases, it may be desirable to provide greater flexibility with respect to the components, such as memory, that are placed on the adapters.

### BRIEF DESCRIPTION OF THE DRAWINGS

FIG. 1 is a bottom plan view of the backside of an adapter in accordance with one embodiment of the present invention is shown;

FIG. 2 is a bottom edge view of the embodiment shown in FIG. 1;

FIG. 3 is a top plan view of the component side of the adapter shown in FIG. 1 in accordance with one embodiment of the present invention; and

FIG. 4 is a schematic depiction of one embodiment of the present invention.

### DETAILED DESCRIPTION

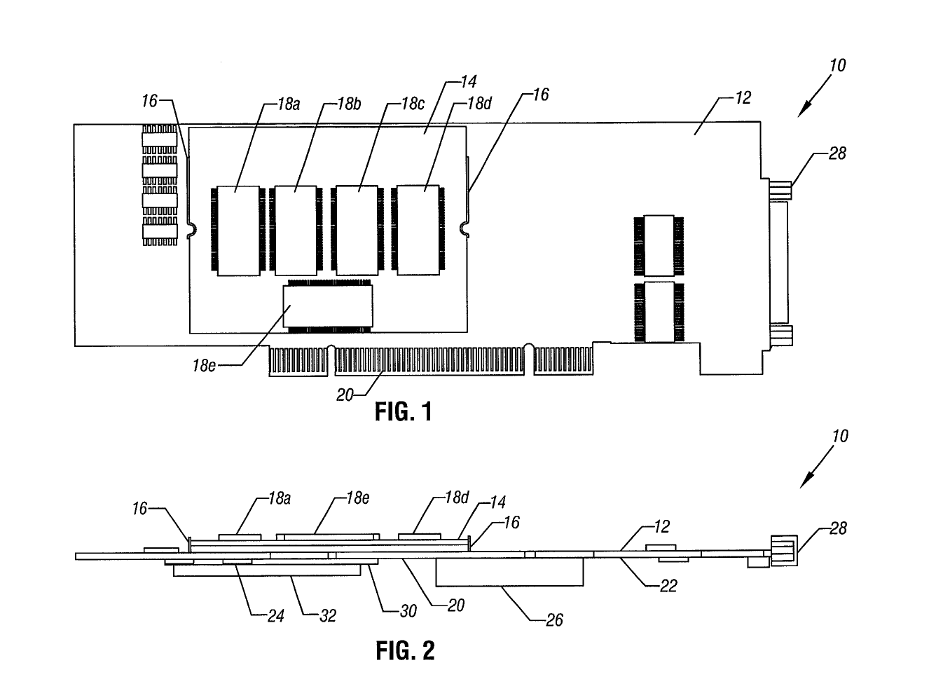

Referring to FIG. 1, an adapter 10 may include a connector 20 to couple the adapter 10 to a bus slot and a connector 28 to couple a peripheral device to the adapter 10 and the rest of a processor-based system. The card 10 may have a backside 12. As used herein, the backside 12 refers to that side of the adapter 10 through which soldered connections are conventionally made. Generally, components or integrated circuits are positioned on the opposite side of the adapter 10. In some cases, the backside 12 can be referred to as the solder side since a variety of components on the component side have pins that extend through the adapter 10 to be soldered on the backside 12.

As shown in FIG. 1, some components may be placed on the backside 12 and in addition, a smaller, separate card 14 is secured, through electrical contacts 16, to the backside 12 of the adapter 10. In one embodiment of the present invention, the card 14 carries a plurality of socketed memory modules 18a through 18e. As a result, the adapter 10 may be distributed with the card 14 but without memory modules 18 in place in vacant sockets.

The memory modules 18 may then be purchased by the end user and inserted into those empty sockets so that the user has control over the characteristics of the memory that is utilized by the adapter 10. As a result, the user can adapt the capabilities and capacities of a particular adapter 10 to suit the user's particular goals and desires.

Moreover, because the memory modules 18 are provided on the backside 12 of the adapter 10, additional space is available on the opposite side or component side of the adapter 10. As a result, low profile PCI adapters may be implemented in some embodiments with a greater number of overall components carried on those adapters. As still another advantage, in some embodiments, memory upgrades can be performed easily through the module area provided by sockets as opposed to fixedly mounted memory modules.

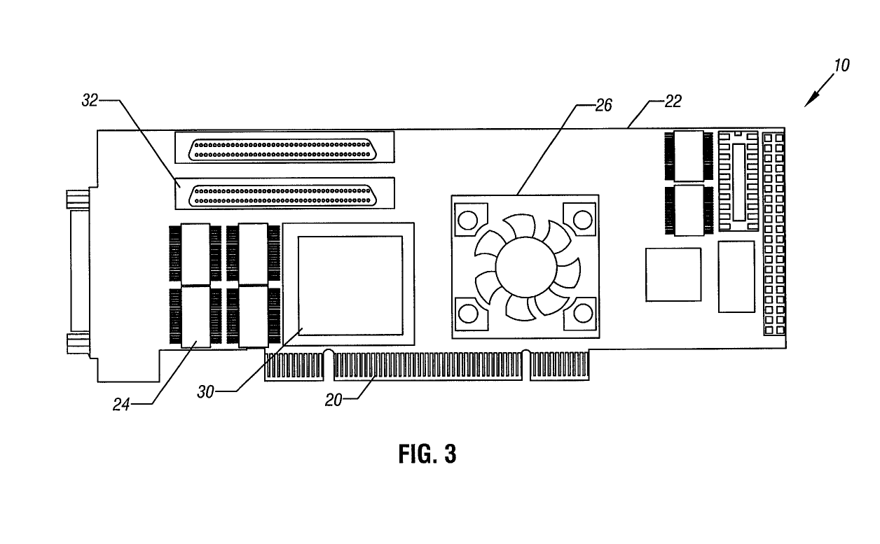

Referring to FIG. 2, showing an edge view of the adapter 10, the connectors 20 and 28 are again indicated. The backside 12 includes the card 14 and the electrical connector 16, with the card 14 supported memory modules 18 carried in sockets in one embodiment of the present invention. Similarly, the component side 22 may include a fan 26, a plurality of sockets 32, a processor 30, and integrated circuits 24. Various component side 22 components are also shown in FIG. 3.

By placing the memory modules 18 on the backside 12 of the adapter 10, additional space is available on the component side 22. In addition, the ease of connection to the memory modules 18 is improved. Also, in some cases, the layout may be enhanced and particularly, the heat dissipation of the components may be more readily ordered.

In accordance with one embodiment of the present invention, the adapter 10 shown in FIGS. 1, 2 and 3 is a low profile RAID controller. Customers are free to choose the desired performance from entry level to advanced levels by selecting the memory modules 18 that are installed by the user on the backside 12 in some embodiments. This may also be advantageous for manufacturers because, the cost of memory fluctuates and the manufacturer is not forced to absorb the varying memory costs or to price the product for the worst memory cost.

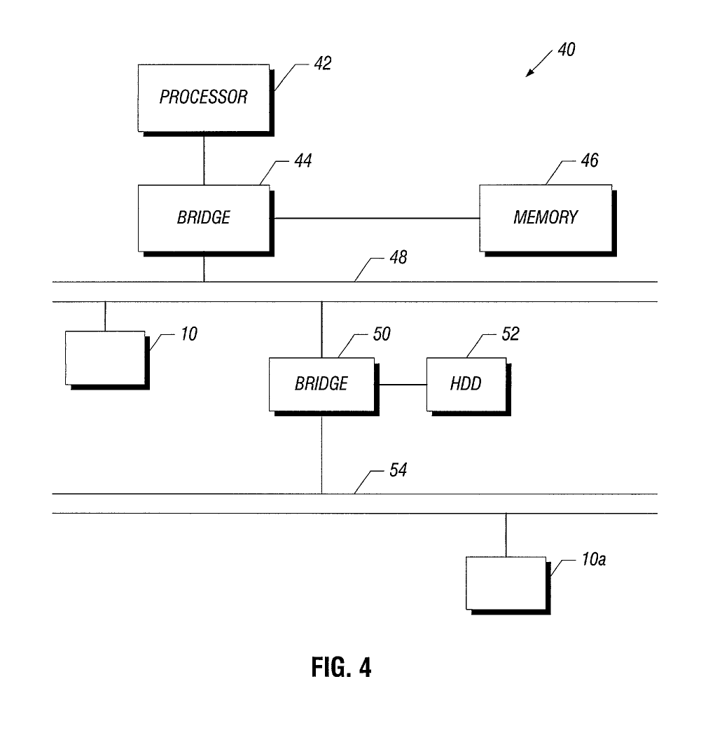

Referring to FIG. 4, a processor-based system 40 may include a processor 42, a memory 46 and an interface 44 such as a bridge. The interface 44 may be coupled to a bus 48. In one embodiment, the adapter 10 is plugged into the bus 48. Thus, the adapter 10 may be a RAID adapter or may be any of a variety of other functions that can be incorporated via an adapter.

In one embodiment, the bus 48 may be coupled to a bridge 50. The bridge 50 may in turn be coupled to a hard disk drive (HDD) 52. The bridge 50 may also be coupled to a secondary bus 54 having a plurality of slots, one of which may be occupied by an adapter 10a that may be the same or different than the adapter 10.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An adapter comprising:
a card having a component side and a backside;
a plurality of components secured to the component side of said card; and
a memory module mount secured to the backside of said card.

2. The adapter of claim 1 wherein said mount includes a printed circuit board, said board including a plurality of memory module connectors to removeably mount memory modules.

3. The adapter of claim 2 including dual in line memory modules in said connectors.

4. The adapter of claim 1 wherein said adapter is a redundant array of independent disks controller.

5. The adapter of claim 3 wherein said component side includes a processor.

6. A method comprising:
providing an adapter including a printed circuit board having a component side and a backside;
placing a plurality of integrated circuits on the component side of said card; and
providing a memory module mount on the backside of said card to receive a memory module.

7. The method of claim 6 including providing a separate board secured to the backside of said card.

8. The method of claim 7 including providing a redundant array of independent drives controller using said card.

9. The method of claim 8 including providing a processor on the component side of said card.

10. The method of claim 7 including enabling memory modules to be removeably plugged into said board.

11. A processor-based system comprising:
a processor;
an interface coupled to said processor;
a bus coupled to said interface;
an adapter coupled to said bus, said adapter including a card having a component side and a backside, a plurality of components secured to the component side of said card, and a memory module mount secured to the backside of said card.

12. The system of claim 11 wherein said mount includes a printed circuit board, said board including a plurality of memory module connectors to removeably mount memory modules.

13. The system of claim 12 including dual in line memory modules in said connectors.

14. The system of claim 11 wherein said adapter is a redundant array of independent disks controller.

15. The system of claim 13 wherein said component side includes a processor.
